(19) United States
(12) Patent Application Publication
(10) Pub. No.: US 2005/0178491 A1
(43) Pub. Date: Aug. 18, 2005

(54) Method and apparatus for attaching article processing stem

(75) Inventor: Liviu L. Marian, Danbury, CT (US)

Correspondence Address: HOWARD S. REITER, ESQ., 158 PROSPECT HILL, NEW MILFORD, CT, 06776, US

(73) Assignee: INTERLAB INCORPORATED, DANBURY, CT (US)

(21) Appl. No.: 10/771,578

(22) Filed: Feb. 3, 2004

(51) Int. Cl. B32B 31/16; B32B 31/20

(52) U.S. Cl. 156/73.1; 156/73.2; 156/308.2; 156/580

(57) ABSTRACT

The disclosed apparatus and method for facilitating surface treatment of articles of manufacture of the type having a given handling surface, such as, for example, blank forms for optical lenses, includes a support for holding the article in a stable position, a source for sequentially aligning elongate stem elements in a desired orientation relative to the article, a mechanism for advancing a free end of the stem into contact with the article, and a securing mechanism [26] for attaching the free end of the stem element to the article so that the stem extends from the article to serve as a handle for manipulation and support during processing. The handle is removed by cutting or breaking away.

### BACKGROUND OF THE INVENTION

1. Field of the Invention

This invention relates generally to the processing of articles of manufacture such as, for example only, optical lenses formed of molded plastic and similarly moldable or extrudable materials. More specifically, this invention relates to the handling of such articles during surface treatment processing, when it is desirable to reduce the number and size of contact areas between an article and the transport equipment that engages the article as it is moved through the treatment process.

2. Description of the Related Art

Automated equipment for transporting articles through surface treatment and other manufacturing processes have been known and widely used for many years. In general, such equipment involves physical gripping devices, often called “chucks” that engage two or more surfaces of the article in the well-known manner of vises or mechanical pincers have two or more jaws.

A serious limitation of the use of such known devices for transporting delicate articles through manufacturing processes that may involve relatively free-flowing materials such as powder or liquids, is the often uncontrolled flow of materials form the transport mechanism onto the article being treated. This is a result of the tendency of such materials to collect, i.e. accumulate, on the structure of the gripping device, and/or between the gripper and the article, at the points of contact. Materials that accumulate in this manner frequently result in adverse effects on the quality of the article being treated, in that the surface of the article may develop undesired drip marks from material flowing off the “chuck” structure, or the intended coatings may develop unintended and undesirable localized variations in specified parameters such as thickness.

The present invention addresses this and other such processing problems by temporarily attaching an “article processing stem” to each article that is to be processed. The processing stem may be attached to the article at substantially any desired point and in any desired orientation to avoid or reduce the adverse effects of material accumulations at the point of attachment. In turn, the stem may then be engaged by any desired form of “chuck” to transport the article through various processes, with significantly reduced possibility of adverse effects on the article itself. And finally, the processing stem, as well as the nature of the joint between the stem and the article may be provided readily with a controlled nature so that the stem can be detached readily from the article, when desired.

The readily detachable article processing stem employed by this invention significantly restricts the possibility of adverse effects resulting from support of an article while it is being treated. This is accomplished at least in part by interposing the detachable stem between the treated article and the relatively standard structure of a transport/gripping chuck mechanism. In this regard, the stem represents a controlled and controllable single-point connection which can be positioned and dimensioned in the most efficacious manner relative to the treatment process. The stem in effect serves to isolate the chuck from the article. That is, the temporary processing stem of the invention represents a “sacrificial” portion of the article, for which adverse processing effects are irrelevant and which may be sacrificed or discarded readily at the end of the desired treatment.

The sacrificial processing stem may be separated readily from the processed article in any suitable and well-known manner such as, for example, physical cutting, or mechanical pulling or breaking, or release of the connection by heating or chemical dissolution. For just one specific example, either the stem or the connection between the stem and the article may be provided with a controlled, frangible nature, allowing one or the other to be broken off easily, when desired. And, as a further example, once the connection has been released, the separated article may be received gently and without damage in a container or receptacle of any suitable kind for further use and handling.

### SUMMARY OF THE INVENTION

The method and apparatus of this invention contemplates the use of a releasable gripping structure for holding articles temporarily in a stable initial position, a supply source of sacrificial stem elements that are to be attached to the articles, an advancing mechanism associated with the stem supply, for advancing the stems sequentially into position for attachment to the articles, and a securing mechanism for attaching a stem to an article when the two items have been positioned relative to each other. Accordingly, it will be made evident that this invention discloses a method of facilitating the handling of articles during processing that comprises gripping the article in a stable position, aligning an elongate sacrificial stem element substantially in contact with the article at a desired contact point, and then attaching a free end of the stem to the article.

### BRIEF DESCRIPTION OF THE DRAWINGS

FIG. 1 is a diagrammatic representation, partially in cross-section, illustrating one embodiment of apparatus in accordance with this invention.

FIG. 2 is a diagrammatic representation illustrating another embodiment of apparatus suitable for practicing the method of this invention.

FIG. 3 is further diagrammatic representation of a variation of the apparatus illustrated in FIG. 1.

### DETAILED DESCRIPTION OF THE PREFERRED EMBODIMENT

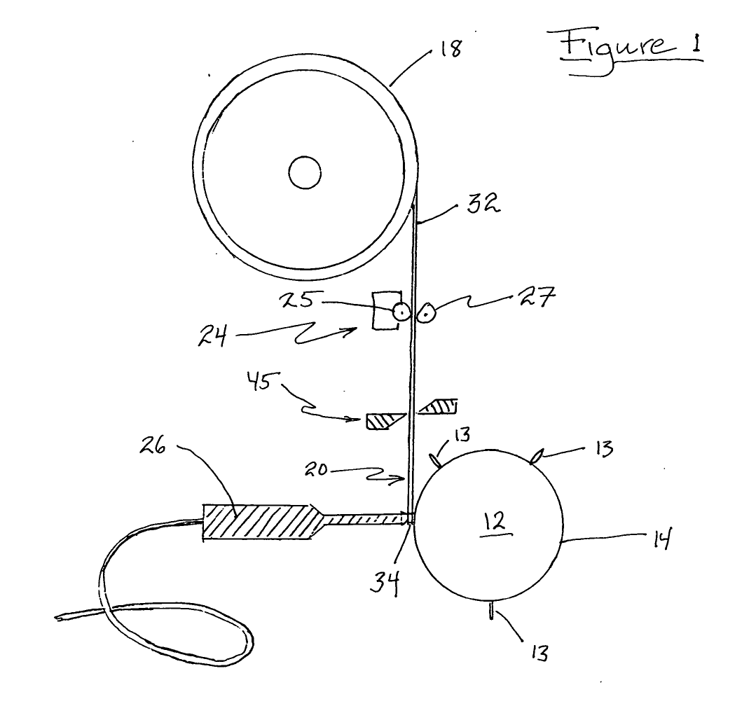

Referring now to FIG. 1 of the drawings, it can be seen readily that an article such as a generally circular, optical lens [12], is engaged by the jaws [13] of a gripping structure or chuck where it is held in a given, substantially fixed position. Article [12] characteristically includes a handling surface [14] which, in the case of the illustrated lens [12] is the outer periphery of the lens thickness. Although the article under discussion is formed of plastic, it will be understood by those skilled in the art, that any suitable material maybe used consistently with the methods and apparatus of this invention.

A source [18] provides individual stem elements [20] substantially one-at-a-time from a supply, in a desired orientation, so that a free end [34] of the element [20] may be engaged with the handling surface [14]of an article [12].

An advancing mechanism [24], which may be as simple as a driven wheel [25] operating against an idler wheel [27], as shown, serves to advance the stem element [20], axially, into the desired contact position relative to the handling surface [14]. It should be understood that the advancing mechanism [24] may be of any known design and that many such designs will be obvious to those having ordinary skill in this art. When the stem element [20] has been positioned as intended it is ready to be attached to the article [12] in accordance with this invention.

At this point in the operation of the invention, a securing mechanism [26] operates on the free end [34] at the point of engagement with the handling surface [14] to form a connection between the free end [34] and the intended surface [14]. Within the scope of the invention as disclosed to this point, the securing mechanism [26] may be of any suitable, known design, such as a conventional heating element. Suitable heating elements for use in accordance with this disclosure will be familiar to those having ordinary skill in this art.

Although a heating element is herein disclosed, it will also be apparent to those skilled in the art, that other methods and forms of attachment may be employed, such as for example, adhesive bonding, ultrasonic welding, and mechanical embedding.

As illustrated in FIG. 1, for purposes of this disclosure, the source [18] of stem elements [32] is a continuous reel of coilable rod material which is dispensed in well-known unreeling fashion through the use of advance mechanism [24] and is readily cut to a desired length by a cutting mechanism of any suitable known design. Unreeling and cutting of given lengths of coiled material in this manner will be well-known to anyone having ordinary skill in this art.

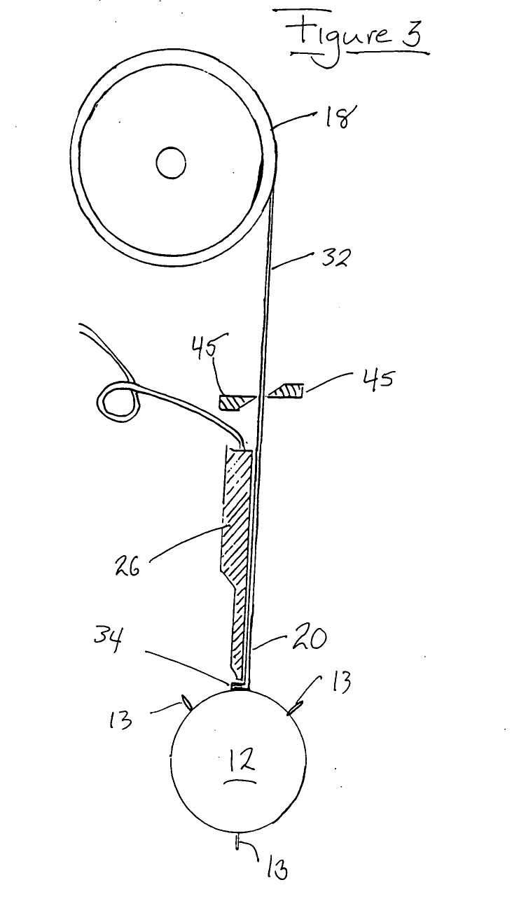

FIG. 3 of the drawings illustrates a modified practice for the apparatus of FIG. 1, in which the free end [34] of stem element [20] is attached to article [12] by first forming a right angle bend so that free end [34] extends normally to the remainder of the stem. It will now be apparent that this approach to the practice of the invention further facilitates attachment of stem [20] to article [12] by allowing free end [34] to be attached tangentially to surface [14] rather than radially as shown in FIG. 1. It will also be apparent that the angle defined by the free end and the body of stem 20 is primarily a matter of choice dependent upon the preferences of the user and the nature of the transport and processing mechanisms being used.

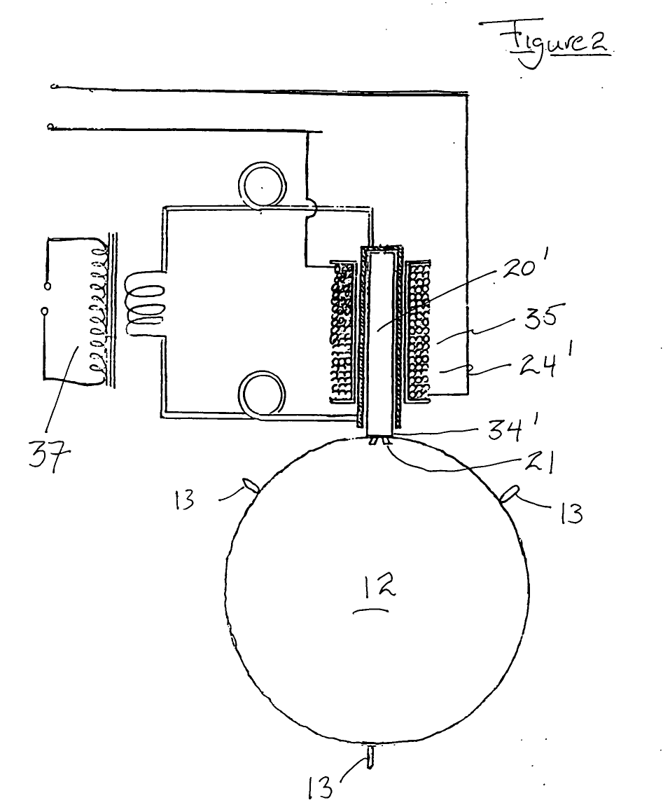

With reference now to FIG. 2 of the drawings, an article [12] again may be seen to be held by three jaws [13] although it should be understood that any combination of two or more jaws may be employed in known fashion for this purpose. In this embodiment of the invention, The stem element [20′] is a metal rod having deformable barbs [21] at is free end [34′ ] for attaching the stem to the article. In this embodiment, the advancing mechanism [24′] is shown to be an electromagnet [35] powered by a power source [37] of any suitable kind, to provide the motive force for advancing barbs [21] into the body of article [12] so that the force of the advance distorts the barbs within the body to form an attachment between the article and the stem. In this regard, the electromagnet may be considered to be the “securing mechanism”, while the “advancing mechanism” for placing the stem 20′ in the illustrated position may be a magazine-feed device of any available design, for advancing a supply of rods [20′] into position within electromagnet [35].

For the purposes of clarity and to simplify the drawings, the feed and advancing apparatus are not shown in this drawing Figure because they are considered to be well known and obvious to anyone having ordinary skill in this art in view of this disclosure.

Although a preferred embodiment of the invention and others have been illustrated and described, it will be obvious to those having skill in this art that various other forms and embodiments of the invention now may be visualized, readily, by those having skill in this art, without departing substantially from the spirit and scope of the invention set forth in the accompanying claims.

1. Apparatus [10] to facilitate surface treatment of articles of manufacture [12] of the type having a given handling surface [14], said apparatus comprising:
a releasable gripping structure [16] for supporting, in a stable position, an article of manufacture [12] of the type having a given handling surface [14];
a source [18] of elongate stem elements [20], said source being positioned to align a given one of said elongate stem elements [20] with the elongate axis [22] thereof in a predetermined orientation relative to said given handling surface of said plastic article;
an advancing mechanism [24] for advancing a free end [34] of said given elongate element [20] into contact with said given handling surface [14] of said plastic article [12]; and
a securing mechanism [26] for fixedly attaching said free end [34] of said given elongate stem element [20] to said given handling surface [14] of said plastic article [12], such that said stem element thereafter fixedly extends from said handling surface to serve as a handle for manipulating and supporting said article.

2. Apparatus in accordance with claim 1 wherein:
said source of elongate stem elements [18] comprises a reel [36] of coilable plastic rod material [38] defining a substantially continuous supply of elongate stem elements [20], said rod material having a captive end retained in association with said reel and a free end [40] defining said one end [34] of said given one of said stem elements [20].

3. Apparatus in accordance with claim 1 wherein:
said source of elongate stem elements [18] comprises a plastic extrusion processor for extruding a plastic stem of predetermined dimensions.

4. Apparatus in accordance with claim 3 wherein:
said advancing mechanism comprises an assembly for axially receiving said extruded stem element from said extrusion processor and axially advancing said stem element into contact with said article of manufacture.

5. Apparatus in accordance with claim 1 wherein:
said source of elongate stem elements [18] comprises a hopper-feed assembly capable of being loaded with a plurality of said stem elements for axially advancing one such element at a time into a predetermined position.

6. Apparatus in accordance with claim 1 wherein:
both said article of manufacture and said stem element are formed of plastic, and
said securing mechanism comprises an ultrasonic welding assembly.

7. Apparatus in accordance with claim 1 wherein:
both said article of manufacture and said stem element are formed of plastic, and
said securing mechanism comprises a chemical bonding assembly.

8. Apparatus in accordance with claim 1 wherein:
both said article of manufacture and said stem element are formed of thermoplastic material, and
said securing mechanism comprises a heating element to form a thermoplastic bond.

9. Apparatus in accordance with claim 1 wherein:
said stem element is formed of metal having deformable barbs thereon, and
said securing mechanism comprises a force-fitting assembly for deforming said barbs within said article.

10. A method for facilitating manipulation of articles of manufacture during surface treatment processing, said method comprising the steps of:
[100] firmly gripping said article of manufacture in a given position;
[200] aligning an elongate processing stem in physical contact with said article of manufacture at a given point of contact; and
[300] physically attaching said processing stem to said article of manufacture at said given point of contact, such that said processing stem can be used as a handle for manipulating and supporting said substrate article.

11. The method of claim 10, wherein:
said processing stem is formed of plastic material; and
said attaching step comprises thermal bonding of said stem to said article of manufacture at said given point of contact.

12. The method of claim 11, wherein:
both said article of manufacture and said processing stem are formed of plastic material.

13. The method of claim 10, wherein:
one end of said stem is bent at an angle relative to the other end therof to achieve a desired orientation of said stem relative to said article.

14. The method of claim 10, wherein:
said processing stem is formed of suitably deformable metal; and
said attaching step comprises axially pressing a portion of said stem into the body of said substrate article and deforming said stem within said substrate article to form a mechanical bond between said body of said article and said portion of said stem.
